(19) United States
(12) Patent Application Publication
(10) Pub. No.: US 2010/0017109 A1
(43) Pub. Date: Jan. 21, 2010

(54) ADDING DESTINATIONS TO NAVIGATION DEVICE

(76) Inventor: Peter-Frans Pauwels, Concord, MA (US)

Correspondence Address: HARNESS, DICKEY & PIERCE, P.L.C., P.O. BOX 8910, RESTON, VA, 20195, US

(21) Appl. No.: 12/310,106

(22) PCT Filed: Sep. 7, 2007
(86) PCT No.: PCT/US2007/077868

§ 371 Date: Jul. 6, 2009

(30) Foreign Application Priority Data
Sep. 7, 2006 (GB) 0617545.9

(51) Int. Cl. G01C 21/36

(52) U.S. Cl. 701/200

(57) ABSTRACT

In one embodiment of the present invention, a navigation system is disclosed including a navigation device for planning a route to a destination, a web server for providing an electronic document and a computing device including an Internet browser application for receiving the electronic document from a web server and displaying the electronic document on a display screen, the electronic document including at least one destination, the navigation system being arranged to add the destination to the navigation device.

This invention relates to a navigation system comprising a navigation device for planning a route to a destination, a web server for providing an electronic document and a computing device comprising an Internet browser application for receiving the electronic document from a web server and displaying the electronic document on a display screen, the electronic document comprising at least one destination, the navigation system being arranged to add the destination to the navigation device.

This invention further relates to a method and a computer program product for adding a destinations to a navigation device.

Usually, users of navigation devices use a user interface on the navigation device itself to specify a destination they want to travel to. Often, a list with possible destinations is displayed on the screen of the navigation device. A destination is picked by moving a cursor through the list and/or by entering some of the first characters of the destination, for filtering the available destinations and shortening the list. Due to the small size of most navigation devices, adding a destination to the navigation device often is an awkward activity. When selecting the destination from the list, it may be added to a favorites list to make it easier to find the selected destination in the future. When a user, e.g., wants to go to a pizzeria, he may use a search engine, such as Google or Yahoo Search, to find pizzerias in the city. Then the user must visit and read the web pages comprised in the search result to find the addresses of the pizzerias. Then, the found addresses have to be added to the navigation device, using the user interface as described above. This procedure takes a lot of time.

It is an object of the invention to provide a more convenient method of adding destinations to navigation devices. According to a first aspect of the invention, this object is achieved by providing a system as described in the opening paragraph, wherein the electronic document comprises at least one destination object, the destination object being associated with destination details of the destination, the destination details at least comprising location information of the destination, the navigation system being arranged to, upon activation of the destination object by a user, communicate the destination details to the navigation device, the navigation device further being arranged to receive the destination details and to plan the route to the destination.

This system allows any business, person or organization to provide a destination object on their web site and enables the user to add destinations to their navigation devices by just selecting the destination object. With this method it is not needed to use the user interface on the navigation device itself, making it much easier to add destinations and plan routes.

In an embodiment of the navigation system according to the invention, the web server is arranged to communicate the destination details by identifying the navigation device to send the destination details to and sending the destination details to the identified navigation device. In this embodiment the user is not even required to connect the navigation device to the computer. Selection of a destination object on a web page causes the web server to add the destination to the navigation device.

Advantageously, the web server is arranged to send a data message to the identified navigation device or to a mobile communication means arranged to communicate with the identified communication means, using a mobile communication technique such as SMS, UMTS or GPRS, the data message comprising the destination details. The navigation device may still be in the user's car, when he selects the destination to be added using his home computer.

According to a further embodiment the web server is arranged to send an e-mail to an e-mail address associated with the identified navigation device, the e-mail comprising the destination details. After receiving the e-mail, the e-mail may be processed to actually add the destination to the navigation device. One advantage of this embodiment is that an e-mail may, e.g., be forwarded to a friend or relative who may also be interested in the destination.

Preferably the navigation device according to the invention is further arranged to register usage statistics of the received destination details. It may be interesting to know, e.g., if and when a user actually uses the destination to plan a route and if the user did actually reach the destination. The usage statistics may be reported to the web server, e.g. for enabling a content provider to adapt the services he offers to the needs of the customers who use the provided content.

The web server may comprise a search engine for generating the electronic document in response to a search query from the computing device, the electronic document comprising a list of search results, at least one search result of the list being associated with a corresponding destination object. In this way, in response to a search request, the search engine may directly provide the option to add, e.g., a pizzeria to the navigation device instead of requiring to visit a web page from the search results, read the web page, find the address and add it to the navigation device.

Furthermore, the electronic document may comprise multiple destination objects and upon a specific user request the destination details of all destination objects in the electronic document are communicated to the navigation device. For example, a web page listing all pizzerias in one city may be added to the navigation device in response to one single request. Also, in response to a search request, the search engine may provide the option to add all locations related to the search result at once.

The Internet browser application may comprise a plug-in for processing the electronic document to detect a text portion comprising location information and generating a destination object, based on the detected text portion. With this plug-in, even addresses on web pages not using destination objects, may be added to the navigation device in the same convenient way as described above.

These and other aspects of the invention are apparent from and will be elucidated with reference to the embodiments described hereinafter.

### BRIEF DESCRIPTION OF THE DRAWINGS

FIG. 1 schematically shows a navigation system according to the invention,

FIG. 2 schematically shows another navigation system according to the invention,

FIG. 3 shows a display showing an electronic document with destination objects, and

FIG. 4 shows a flow diagram of a method according to the invention.

### DETAILED DESCRIPTION OF THE INVENTION

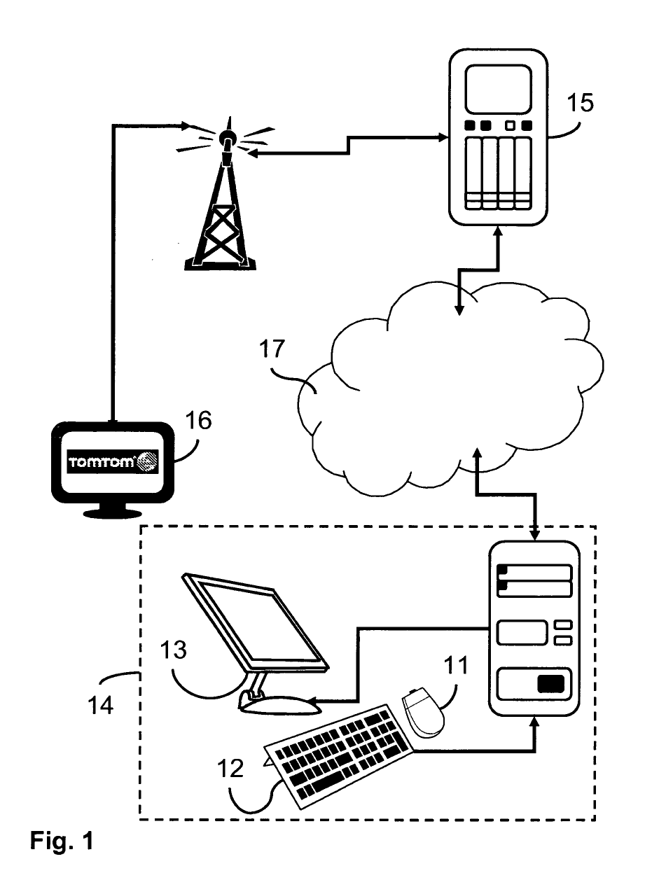

FIG. 1 schematically shows a navigation system according to the invention. The navigation system comprises a navigation device 16, a computing device 14 and a web server 15. The computing device 14 is connected to the web server 15 via a public or private network 17. Preferably the network 17 is a public wide area network, such as the Internet. The navigation device 16 may be a dedicated satellite navigation device for planning routes in, e.g., cars, bikes or when walking. Generally such a navigation device 16 comprises a GPS sensor for determining a current position of the navigation device 16. Other suitable techniques may be used as an alternative or additionally, e.g., using information derived from cell based wireless communication systems, such as GSM, UMTS, GPRS, WiFi or WiMAX. The navigation device 16 is operative to calculate a shortest, fastest or otherwise optimal route from its current position to a certain destination. The navigation device 16 comprises a user interface for enabling a user to specify the destination for which a route should be planned. The computing device 14 may, e.g., be a personal computer, laptop computer or handheld device. Alternatively, the computer 14 may be built-in in a car. The computing device 14 is arranged to run an Internet browser application for receiving, interpreting and displaying electronic documents, received from the web server 15, via network 17. The computing device 14 comprises display 13 and a user interface with, e.g., a keyboard 12 and a mouse 11 or other type of pointing device. The navigation system according to the invention provides the opportunity to add destinations to the navigation device 16 in a convenient way.

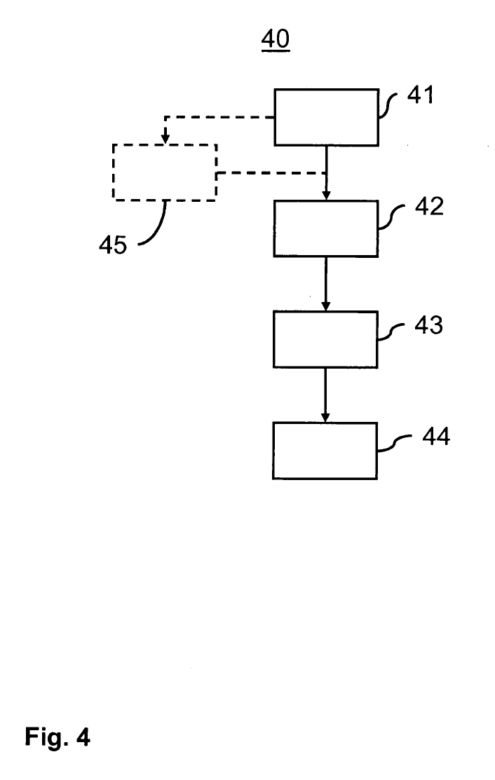

In the system as shown in FIG. 1, the adding of a destination to the navigation device 14 may, e.g., be realized in the following manner. The user is at home and uses a computer 14 and in Internet browser application to read electronic documents provided by a web server 15, via the Internet 17. The Internet browser may be any current or future standard browser application, such as Opera, Firefox or Internet Explorer that is capable of obtaining electronic documents via the Internet 17 and displaying content comprised in the electronic documents on the display 13. While browsing the Internet, the user may, intentionally or accidentally, find an electronic document comprising a destination object. Destination objects are discussed in detail below, with reference to FIG. 4. For now it is enough to known that a destination object is recognizable as such when displayed and that the destination object is associated with destination details of a particular destination.

When the user activates the destination object, e.g., by clicking on it using the mouse 11 or pressing ‘Enter’ when a focus is on the object, a request is sent to the web server 15 via the Internet 17 to add the destination details to the navigation device 16 of the user. Before sending the destination details to the navigation device 16, the web server 15 must know which navigation device 16 belongs to the user. Many options are available for how to identify the navigation device 16 to send the destination details to. For example, if the electronic document is part of a web site to which the user is logged in, the identification of the navigation device 16 may be stored in a user profile that is already present at the web server 15. Alternatively, a browser cookie comprising the identification may be stored at the user's computer 14 and may thus be used to provide the identification to the web server. Possibly, the user is requested to submit an identification of the navigation device, e.g., by entering such information in an input field of a pop-up window. An advantage of requesting the user to submit the identification is that the user may choose to add the destination to a navigation device of his choice. Preferably, some sort of user authentication is used to prevent unauthorized persons to add destinations to someone else's navigation device.

In FIG. 1, the sending of the destination details is performed using mobile communication means. For example, SMS, UMTS or GPRS data messages may be used to send the destination details from the web server 15 to the navigation device 16. For using mobile communication means it is necessary that the navigation device 16 comprises communication means capable of receiving the data message, or that the navigation device 16 is arranged to communicate with such mobile communication means. For example, the navigation device 16 is coupled to a mobile phone, e.g., via a wire or via Bluetooth. The mobile phone unit may be a handheld device or fixed built-in device, e.g. built-in in a car. Preferably, the navigation device 16 provides feedback to the web server 15, using the same communication means as for receiving the destination details. The feedback may, e.g., comprise an acknowledgement that the destination details have arrived successfully, information about whether or when the destination details are used for planning a route or information about whether the user did actually go to the destination. Such feedback information may assist the content provider of the electronic document in adapting the services offered to the needs and behavior of the users.

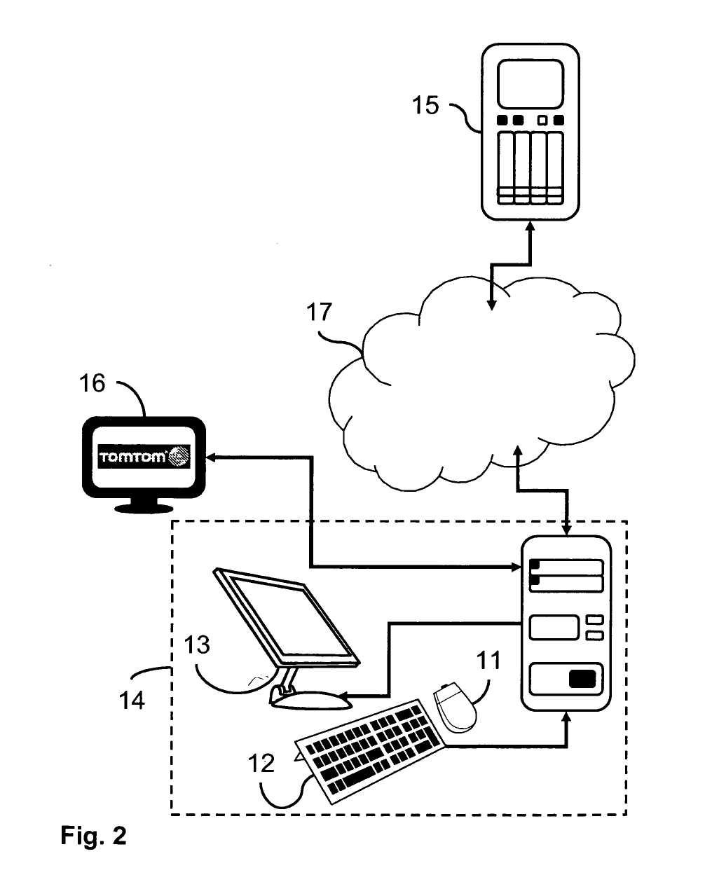

FIG. 2 schematically shows another navigation system according to the invention. The navigation system of FIG. 2 is similar to the navigation system of claim 1. The main difference is in the way of communicating the destination details to the navigation device 16. In FIG. 2, the navigation device 16 is coupled to the computer 14. The coupling may be realized using local communication means, such as USB, infrared communication or Bluetooth. The computer 14 and the navigation device 16 may be temporarily disconnected, but the adding of the destinations can only be completed after the computer 14 and the navigation device 16 are reconnected. Alternatively, a portable storage medium, such as an USB memory stick, is used to transport the destination details to the navigation device. Upon the user activation of the destination object, the computer 14 obtains the destination details from the web server 15 or extracts the destination details from the electronic document. Then, a browser plug-in or a special dedicated software tool sends the obtained destination details to the navigation device 16. The computer may comprise a special synchronization folder for storing the destination details. The special folder is synchronized with a portion of the memory of the navigation device 16, when the navigation device 16 is connected to the computer 14.

It is to be noted that the navigation device 16 may be arranged to visit the Internet 17 and browse web pages. In that event, the functions of the computer 14 and the navigation device 16 in FIG. 1 or 2 are combined.

In an embodiment of the system according to the invention, the user activation of the destination object causes the web server 15 to send an e-mail to an e-mail address associated with the navigation device 16. In this embodiment, the identifying of the navigation device 16 to send the destination details to, thus comprises determining the e-mail address to send the destination details to. The e-mail sent comprises the destination details and is created according to a predetermined format. The e-mail is then received by the user and added to the navigation device 16. Because the navigation device 16 will generally not be able to recognize the e-mail as a destination, software at the user's computer 14 processes the received e-mail and extracts the destination details there from, before sending the destination details to the navigation device 16.

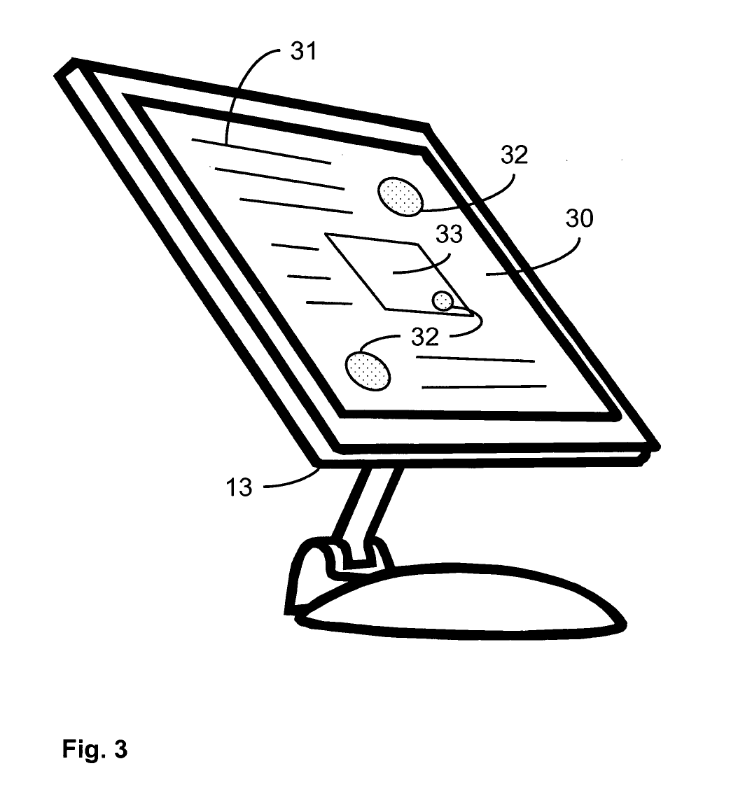

FIG. 3 shows a display 13 showing an electronic document 30 with destination objects 32. The electronic document 30 may be a HTML or XML document or any other type of document that can be displayed on a computer display 13. In FIG. 3, the electronic document 30 comprises text 31, formatting and pictures 33, but the invention is also applicable to electronic documents that only comprise text. The electronic document 30 shown in FIG. 3 comprises three destination objects 32. Preferably, the destination object 32 is displayed as an easily recognizable logo and is placed close to text 31 or pictures 33 which relate to a destination. Alternatively, text portions relating to a destination are highlighted in a predefined manner to indicate that the portions represent destination objects.

The destination details may already be part of the received electronic document 30. The destination details may be hidden in the electronic document or may be displayed together with the other text 31 and pictures 32 in the document. Alternatively, the destination object 32 only comprises a reference to the destination details and the destination details are available on the web server 15 for sending to the navigation device 16 when the user activates the destination object.

The destination details may comprise more information than location information of the destination only. E.g., the destination details mat comprise a telephone number, description or even photo of the destination. When the destination is a restaurant, the destination details may comprise a menu. When the destination is a hotel, the destination details may comprise room rates. Preferably, the destination details only comprise indexing information or indexing tags for enabling the navigation device 16 to sort the added destination in a logic way, making it easier for the user to find the destination for planning future routes.

Optionally, the electronic document 30 may comprise an ‘add all’ button to add all destinations disclosed in the electronic document 30 at once. Alternatively, the ‘add all’ function may be a built-in function of the browser. Another optional built-in browser function may be a possibility to list or search a history of displayed and/or selected destination objects 32. Another option is a function to analyze the text in a received document to find portions describing locations. E.g. address information may be detected. If the destination details of the location are also extracted from the electronic document, a destination object is generated and displayed as part of the electronic document. If the destination details are not found in the original electronic document, an Internet search may be used for obtaining the missing information. A generated destination object may or may not look like any other destination object 32. The additional browser functions described above may be built-in functions of a specially adapted Internet browser application, or may be provided as plug-ins for a standard Internet browser application.

The electronic document 30 may be a search results page, provided by a search engine in response to a search request. For example, a user may want to go to a pizzeria in Rome. The user then visits the web site of a search engine, e.g. Google or Yahoo Search and sends a search request for “pizzeria+Rome” to the web server 15. In response, the search engine sends a results page, comprising hyperlinks to web sites of pizzerias in Rome. Without the system according to the invention, the user would then have to follow a hyperlink and search for address information on the web site of a pizzeria. Then he would have to add the address to the navigation device 16 as a destination, using the user interface of the navigation device 16. With the system according to the invention, the search results page may comprise destination objects, additional to the hyperlinks. Now the user can add the pizzeria to the navigation device, simply by clicking on the destination object 32. Preferably, the navigation device 16 provides feedback to the search engine about the usage of the added destinations. If many users add the destination or even travel to the pizzeria, the search engine may decide to suggest the pizzeria more often. Similarly, advertisements may comprise destination objects for making it easier for the user to find the corresponding business. Feedback information, may inform the business about the success of the advertisement.

Advantageously, the search request may comprise a term, indicating that a destination object is searched. In the example used above, the query may, e.g., be formulated as “pizzeria+Rome+TomTom”. The search engine may then respond with a list of search results, wherein all search results are accompanied by a destination object.

FIG. 4 shows a flow diagram of a method 40 according to the invention. The method comprises a receiving step 41 for receiving the electronic document 30. In an optional processing step 45, destination objects may be generated from the location information comprised in the document 30. In display step 42, the electronic document 30 and its destination objects 32 are displayed. In selection step 43 the user selects one or more destinations to add to the navigation device 16. Thereafter, in communication step 44, the destination details associated with the activated destination object are communicated to the navigation device 16. The communicating of the destination details is performed as described above with reference to FIGS. 1 and 2.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A navigation system comprising: a navigation device for planning a route to a destination,
a web server for providing an electronic document,
and a computing device comprising an Internet browser application for receiving the electronic document from the web server and displaying the electronic document on a display screen, the electronic document comprising at least one destination object, the destination object being associated with destination details of the destination, the destination details at least comprising location information of the destination,
the navigation system being arranged to, upon activation of the destination object by a user, communicate the destination details to the navigation device,
the navigation device being arranged to receive the destination details and to plan the route to the destination.

2. A navigation system as claimed in claim 1, wherein the web server is arranged to communicate the destination details by:
identifying the navigation device to send the destination details to, and
sending the destination details to the identified navigation device.

3. A navigation system as claimed in claim 2, wherein the web server is arranged to send a data message to the identified navigation device or to a mobile communication means arranged to communicate with the identified navigation device, using a mobile communication technique such as SMS, UMTS or GPRS, the data message comprising the destination details.

4. A navigation system as claimed in claim 2, wherein the web server is arranged to send an e-mail to an e-mail address associated with the identified navigation device, the e-mail comprising the destination details.

5. A navigation system as claimed in claim 4, wherein the computing device is arranged for receiving and processing the e-mail to add the destination details to the navigation device using a local communication means, such as USB or Bluetooth communication.

6. A navigation system as claimed in claim 1, wherein the destination details further comprise at least one of a name and description of a person, business or organization situated at the destination.

7. A navigation system as claimed in claim 1, wherein the destination details further comprise at least one of a telephone number and e-mail address of a person, business or organization situated at the destination.

8. A navigation system as claimed in claim 1, wherein the navigation device is arranged to register usage statistics of the received destination details.

9. A navigation system as claimed in claim 8, wherein the navigation device is further arranged to report the usage statistics to the web server.

10. A navigation system as claimed in claim 1, wherein the web server comprises a search engine for generating the electronic document in response to a search query from the computing device, the electronic document comprising a list of search results, at least one search result of the list being associated with a corresponding destination object.

11. A navigation system as claimed in claim 1, wherein the electronic document comprises multiple destination objects and wherein, upon a specific user request, the destination details of all destination objects in the electronic document are communicated to the navigation device.

12. A navigation system as claimed in claim 2, wherein the web server is arranged to read an earlier installed cookie at the computing device to identify the navigation device to send the destination details to, the cookie comprising an identification of said navigation device.

13. A navigation system as claimed in claim 2, wherein the web server is arranged to request the user to provide information identifying the navigation device to send the destination details to.

14. A navigation system as claimed in claim 1, the Internet browser comprising a plug-in for processing the received electronic document to detect a text portion comprising location information, and for generating a destination object based on the location information.

15. A method of adding a destination to a navigation device for planning a route, the method comprising:
receiving, in an Internet browser application, an electronic document from a web server and displaying the electronic document on a display screen, the electronic document including at least one destination object, the destination object being associated with destination details of the destination, the destination details at least comprising location information of the destination; and
communicating, upon activation of the destination object by a user,—the destination details of the destination to the navigation device.

16. A computer program product for adding a destination to a navigation device which program is operative to cause a processor to perform the method as claimed in claim 15.

17. A computer program stored on a computer readable medium, the computer program comprising:
a program portion arranged to receive an electronic document from a web server,
a program portion arranged to display the electronic document on a display screen, the electronic document comprising at least one destination object, the destination object being associated with destination details of the destination, the destination details at least comprising location information of the destination, and
a program portion arrange to communicate the destination details of the destination to the navigation device, upon activation of the destination object by a user.
